(19) United States
(12) Patent Application Publication
(10) Pub. No.: US 2013/0022477 A1
(43) Pub. Date: Jan. 24, 2013

(54) TURBINES WITH INTEGRATED COMPRESSORS AND POWER GENERATORS

(71) Applicant: Paul Lees, San Francisco, CA (US)

(72) Inventor: Paul Lees, San Francisco, CA (US)

(73) Assignee: Caitin, Inc., Fremont, CA (US)

(21) Appl. No.: 13/552,553

(22) Filed: Jul. 18, 2012

Related U.S. Application Data
(60) Provisional application No. 61/509,069, filed on Jul. 18, 2011.

(51) Int. Cl. F03D 9/00; F03D 11/02

(52) U.S. Cl. 417/53; 417/313

(57) ABSTRACT

A turbine system comprises a rotor operatively coupled to a plurality of blades, at least one blade of the plurality of blades having one or more blown passages for providing a pressurized fluid to a pressure side and/or suction side of the at least one blade. The rotor is selectively or simultaneously coupled to a compressor and a power generator. In some situations, the rotor is selectively coupled to one of the power generator and the compressor with the aid of a clutch.

### CROSS-REFERENCE

This application is related to U.S. Provisional Patent Application Ser. No. 61/442,761, filed on Feb. 14, 2011; U.S. Provisional Patent Application Ser. No. 61/453,941, filed on Mar. 17, 2011; and U.S. Provisional patent application Ser. No. ______ (Attorney Docket No. 39896-709.101), filed on Jul. 18, 2011 (“TURBINE BLADES AND SYSTEMS WITH FORWARD BLOWN SLOTS”), which are entirely incorporated herein by reference.

### STATEMENT AS TO FEDERALLY SPONSORED RESEARCH

This invention was made with Government support under DE-00000022 awarded by the United States Department of Energy. The Government has certain rights in the invention.

### BACKGROUND OF THE INVENTION

A turbine is a rotary engine that may extract energy from a fluid flow and convert it into work. Turbines may have one or more moving parts, including a rotary assembly, which is a shaft or drum with blades.

A wind turbine (or wind generator) is a device that may convert kinetic energy from wind or other moving fluid into mechanical energy, which may subsequently be used to generate electricity.

### SUMMARY OF THE INVENTION

In an aspect of the invention, turbine systems comprise integrated power generators and compressors. In an embodiments, a turbine system comprises a rotor coupled to a plurality of blades, at least one blade of the plurality of blades having one or more blown passages for providing a pressurized fluid to a pressure side and/or suction side of the at least one blade, the rotor configured to rotate upon the flow of a fluid over the one or more blades; a clutch operatively coupled to the rotor; a power generator operatively coupled to the clutch, the power generator configured to generate power upon the coupling of the rotor to the power generator with the aid of the clutch; and a compressor operatively coupled to the clutch, the compressor having one or more passages in fluid communication with the one or more blown passages of the at least one blade, the compressor configured to generate the pressurized fluid upon the coupling of the rotor to the compressor with the aid of the clutch. In some situations, the clutch is configured to selectively and alternately couple the rotor to the compressor and the power generator.

In another embodiment, a turbine system comprises a rotor selectively coupled to a compressor and a power generator with the aid of a clutch, the rotor operatively coupled to a plurality of blades, at least one blade of the plurality of blades having one or more blown passages for providing a pressurized fluid to a pressure side and/or suction side of the at least one blade. The clutch in some cases is configured to selectively and alternately couple the rotor to the compressor and the power generator.

In another aspect of the invention, methods for generating power from turbine systems are provided. In an embodiment, a method for generating power form a turbine system comprises providing a turbine system having a rotor selectively coupled to a compressor and a power generator with the aid of a clutch, the rotor operatively coupled to a plurality of blades, at least one blade of the plurality of blades having one or more blown passages for providing a pressurized fluid to a pressure side and/or suction side of the at least one blade; coupling the rotor to one of the power generator and the compressor; and coupling the rotor to the other of the power generator and the compressor. Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a wind turbine having a clutch, rotor, compressor and power generator, in accordance with an embodiment of the invention;

FIG. 2 shows a wind turbine having a clutch, rotor, compressor and power generator, with the rotor coupled to the compressor with the aid of the clutch, in accordance with an embodiment of the invention;

FIG. 3 shows a wind turbine having a clutch, rotor, compressor and power generator, with the rotor coupled to the power generator with the aid of the clutch, in accordance with an embodiment of the invention;

FIGS. 4A-4D schematically illustrate various configurations of an integrated power generator and compressor, in accordance with various embodiments of the invention;

FIG. 5A schematically illustrates a blade for use with a wind turbine, in accordance with an embodiment of the invention; and

FIG. 5B schematically illustrates a blade for use with a wind turbine, in accordance with an embodiment of the invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed in practicing the invention.

The term “fluid,” as used herein, refers to a gas or liquid. In some embodiments, a fluid is a gas or liquid having low or substantially low viscosity. A fluid may include, for example, air, oxygen, hydrogen, water vapor, an inorganic liquid, or an organic liquid, such as liquid water, an alcohol, an aldehyde, or a ketone. A fluid has various fluid properties, such as heat capacity, viscosity, temperature, pressure and flow rate.

The term “lift,” as used herein, refers to aerodynamic or hydrodynamic lift. Lift is the component of aerodynamic force perpendicular to the direction of motion of the airfoil or blade section.

The term “drag,” as used herein, refers to the component of aerodynamic or hydrodynamic force parallel to the direction of motion of an airfoil or blade section.

The term “blade,” as used herein, refers to an object that is configured to generate lift upon the flow of a fluid over surfaces of the blade. A blade has a pressure side, suction side, leading edge and trailing edge. The pressure side and suction side are for generating lift with the flow of fluid (e.g., air) over the blade. In some instances, a blade is used to provide mechanic motion to a turbine generator. In such context, the blade may be referred to as a “turbine blade”.

The term “airfoil” (or “aerofoil” or “airfoil section”), as used herein, refers to the cross-sectional shape of a blade. A blade may have one or more airfoils. In an example, a blade has a cross-section that is constant along a span of the blade, and the blade has one airfoil. In another example, a blade has a cross-section that varies along a span of the blade, and the blade has a plurality of airfoils.

The term “planform,” as used herein, refers to the shape of the blade viewed from a top-down standpoint defined by airfoil positions and chord lengths.

The term “passageway,” as used herein, refers to a conduit, channel or other structure configured to direct a fluid from one point to another. A fluid flows through a passageway in various flow configurations, such as, e.g., turbulent or laminar flow. A passageway is generally in fluid communication with one or more other passageways or orifices.

The term “orifice,” as used herein, refers to a hole or opening configured to direct a fluid from a chamber or a passageway to an external environment or another chamber or passageway. An orifice may have various shapes, sizes and configurations. In an example, an orifice is circular, oval, elliptical, triangular, square, rectangular, pentagonal, hexagonal, heptagonal, nonagonal, decagonal, or partial segments of these shapes. An orifice may be a slit. An “orifice” may also be referred to as a “slot”.

The term “blown passage,” as used herein, refers to an orifice for providing a pressurized fluid to a pressure side, suction side, leading edge or trailing edge of a blade.

The term “blowing,” as used herein, may refer to the application of a pressurized fluid, such as pressurized air, through one or more orifices or openings in fluid communication with a pressure side and/or suction side of a blade. Blowing in some cases refers to act or process of providing a pressurized and/or moving fluid, such as a pressurized gas or liquid, through an orifice. In an example, blown air includes pressurized air.

The term “span,” as used herein, refers to the radial distance from a root portion of a blade towards a tip portion of the blade.

The term “chord,” as used herein, refers to the distance from a leading edge of a blade airfoil section to a trailing edge of the blade airfoil section. Blades provided herein may have constant chords as measured along a span of the blade.

The term “suction side,” as used herein, refers to suction side of a blade. The term “pressure side”, as used herein, refers to the pressure side of a blade. Upon the flow of air or other fluid over the blade, the fluid pressure at the pressure side may be generally greater than the fluid pressure at the suction side.

The term “leading edge,” as used herein, refers to a portion of a blade that faces the direction of flow of a fluid.

The term “trailing edge,” as used herein, refers to a section of a blade that faces (or is oriented) downstream in relation to the direction of flow of a fluid over the blade.

The term “turbine,” as used herein, refers to a machine, device or system that generates power when a wheel or rotor fitted with vanes or blades is made to revolve within the flow of a fluid. A turbine configured to generate power from wind is referred to as a “wind turbine” herein. In some cases, a turbine includes an induction generator for converting mechanical energy to electricity.

The term “non-aerodynamic,” as used herein, means a device or structure exhibiting separated flow. A blade is non-aerodynamic or exhibits poor aerodynamics if the blade exhibits separated flow upon the flow of air over the blade.

The term “clutch,” as used herein, refers to a mechanical device that provides for the transmission of power (and in some cases motion) from one component (“the driving member”) to another (“the driven member”). In an example, the driving member is the rotor of a turbine and the driven member is one or both of a compressor and power generator of the turbine. A clutch in some cases is a device that takes a variable amount of power from a main shaft of a rotor to power a compressor (or blower).

The term “compressor,” as used herein, refers to a device, apparatus or a plurality of devices or apparatuses for pressurizing (or compressing) a gas from a first pressure to a second pressure, with the second pressure being higher than the first pressure. A compressor in some cases is a gas compressor.

The term “power generator,” as used herein, refers to a device, apparatus or a plurality of devices or apparatuses for generating power. In an example, a power generator is an induction generator.

### Turbine Systems

In an aspect of the invention, a turbine system is configured to generate power and/or a pressurized fluid upon the flow of a fluid over a plurality of blades. In some embodiments, the turbine system comprises a rotor, a clutch, a compressor and a power generator. The rotor is coupled to a plurality of blades, at least one blade of the plurality of blades having one or more blown passages for providing a pressurized fluid to a pressure side and/or suction side of the at least one blade. The rotor is configured to rotate upon the flow of a fluid over the one or more blades. The clutch is operatively coupled to the rotor. The power generator is operatively coupled to the clutch. The power generator is configured to generate power upon the coupling of the rotor to the power generator with the aid of the clutch. The compressor is operatively coupled to the clutch. The compressor has one or more passages in fluid communication with the one or more blown passages of the at least one blade. The compressor is configured to generate the pressurized fluid upon the coupling of the rotor to the compressor with the aid of the clutch. As an alternative to (or in conjunction with) the compressor, the turbine system includes a blower for providing the pressurized fluid.

Upon the flow of a fluid (e.g., air) over the plurality of blades, aerodynamic lift generated in the blades turns the rotor. The generator produces power upon the turning of the rotor and the transmission of mechanical energy from the rotor to the power generator. In situations in which the power generator is an induction generator, the transmission of mechanical energy from the rotor to the power generator produces power via induction. The compressor, which may be a single or multi-state compressor, compresses a fluid (e.g., air), produces a pressurized fluid (e.g., pressurized air) upon the turning of the rotor and the transmission of mechanical energy from the rotor to the compressor.

In some embodiments, the plurality of blades have 1 or more, 2 or more, 3 or more, 4 or more, 5 or more blades having blown passages. The blown passages may be disposed at the pressure side, suction side, leading edge and/or trailing edge of the blade. In an embodiment, the blown passages are disposed at the suction side. In some situations, a blown passage is configured to direct a pressurized fluid (e.g., air) toward the leading edge at an angle between about 0° and 90° with respect to a plane parallel to a surface of the suction side at or adjacent the blown passage. In other situations, a blown passage is configured to direct a pressurized fluid (e.g., air) toward the trailing edge at an angle between about 0° and 90° with respect to a plane parallel to a surface of the suction side at or adjacent the blown passage.

In some embodiments, the clutch is configured to selectively and alternately couple the rotor to the compressor and the power generator. That is, with the compressor coupled to the rotor, the power generator is decoupled from the rotor, and with the power generator coupled to the rotor, the compressor is decoupled from the rotor. In such a case, the pressurized fluid and power are alternately and selectively generated.

In an example, the clutch couples the rotor to the compressor. The flow of a fluid over the plurality of blades turns the rotor which in turn drives the compressor to generate pressurized air. The pressurized air is directed to the blown passages of the at least one blade having one or more blown passages. As described in, for example, U.S. patent application Ser. No. ______ (Attorney Docket No. 39896-705.201), filed on Jul. 18, 2011 (“TURBINE BLADES, SYSTEMS AND METHODS”), which is entirely incorporated herein by reference, the application of pressurized air to the blown passages (e.g., a blown passage at the suction side of a blade) may reduce or eliminate flow separation over the suction side of the at least one blade, which in turn provides improved aerodynamic lift to the blade. In some situations, the application of pressurized air to the blown passages (e.g., a blown passage at the pressure side of a blade) may provide a breaking function to the blades, thereby reducing or stopping the rotation of the rotor. This may advantageously preclude the need of a mechanical breaking system, as found in at least some turbines currently available.

With the rotor coupled to the compressor, the power generator is idle and no power is generated upon rotation of the rotor.

In another example, the clutch couples the rotor to the power generator. The flow of a fluid over the plurality of blades turns the rotor which in turn drives the power generator to generate power. Power may be directed to a power grid, a energy storage unit (e.g., battery), or both. With the rotor coupled to the power generator, the compressor is idle and a pressurized fluid is not generated.

In some embodiments, the clutch couples the rotor to both the power generator and the compressor such that the rotation of the rotor drives both the power generator and the compressor, thereby simultaneously generating power and a pressurized fluid. In other embodiments, the turbine system does not include a clutch. The rotor is directly coupled to both the compressor and the power generator such that the rotation of the rotor drives both the power generator and the compressor, thereby simultaneously generating power and a pressurized fluid. In such cases, the pressurized fluid and power are simultaneously generated.

In some embodiments, the clutch selectively and alternately couples the rotor to the compressor and the power generator. This permits the coupling of the rotor to either the compressor or the power generator, as desired, for the generation of a pressurized fluid or power.

In some embodiments, a turbine system comprises a rotor selectively coupled to a compressor and a power generator with the aid of a clutch. The rotor is operatively coupled to a plurality of blades, at least one of the plurality of blades having one or more blown passages for providing a pressurized fluid to a pressure side and/or suction side of the at least one blade.

In some embodiments, the clutch decouples one or both of the power generator and the compressor from the rotor. With the power generator decoupled from the rotor, the power generator does not generate power upon the rotation of the rotor. With the compressor decoupled from the rotor, the compressor does not generate a pressurized fluid (e.g., a pressurized gas, such as pressurized air) upon the rotation of the rotor.

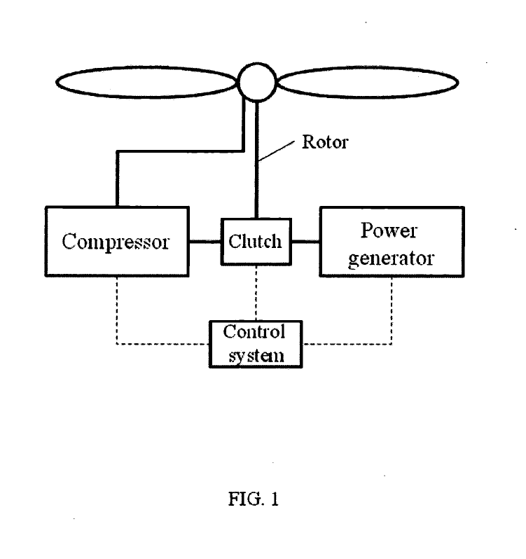

FIG. 1 shows a turbine system having a plurality of blades (two shown), a clutch, a rotor, a compressor and a power generator, in accordance with an embodiment of the invention. The rotor is coupled to the plurality of blades such the rotor is configured to rotate upon the generation of aerodynamic lift in the plurality of blades. The clutch is configured to couple the rotor to the compressor and the power generator. The system of FIG. 1 includes a control system for measuring various processing parameters (e.g., air pressure, temperature, flow rate), and for regulating the operation of one or more of the clutch, the compressor and the power generator. The control system is configured to selectively couple the rotor to the compressor or the power generator with the aid of the clutch. In an example, the control system directs the clutch to couple the rotor to the power generator. In another example, the control system directs the clutch to couple the rotor to the compressor.

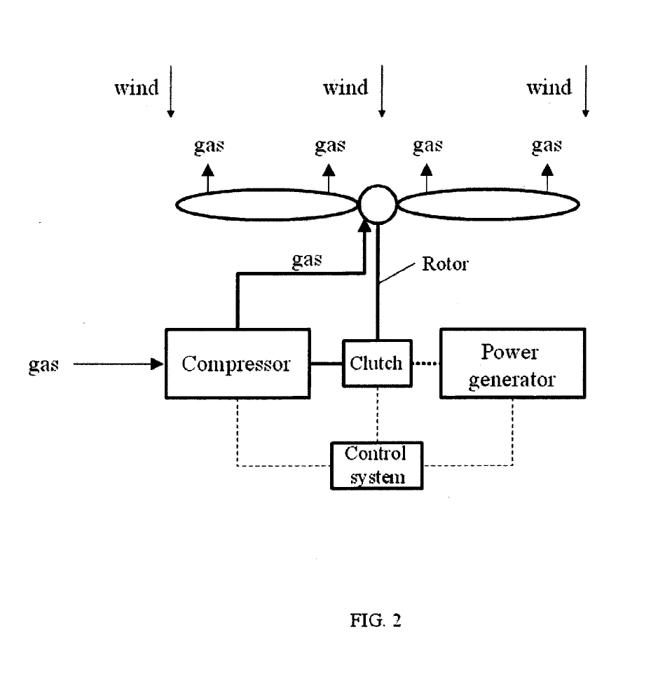

With reference to FIG. 2, the clutch of FIG. 1 has coupled the rotor to the compressor, as illustrated by the solid line between the rotor and the compressor. The flow of air (wind) over the blades turns the rotor, which in turn turns the compressor to generate a pressurized gas (e.g., air) in one or more stages of the compressor. Gas is directed to the compressor, which compresses (or pressurizes) the gas. Pressurized as is then directed to one or more blown passages of the blades. The gas then exits the one or more blown passages, which may aid in minimizing or eliminating the separation of flow over the blades. In the example of FIG. 2, the power generator is decoupled from the rotor, as illustrated by a broken line between the power generator and the rotor.

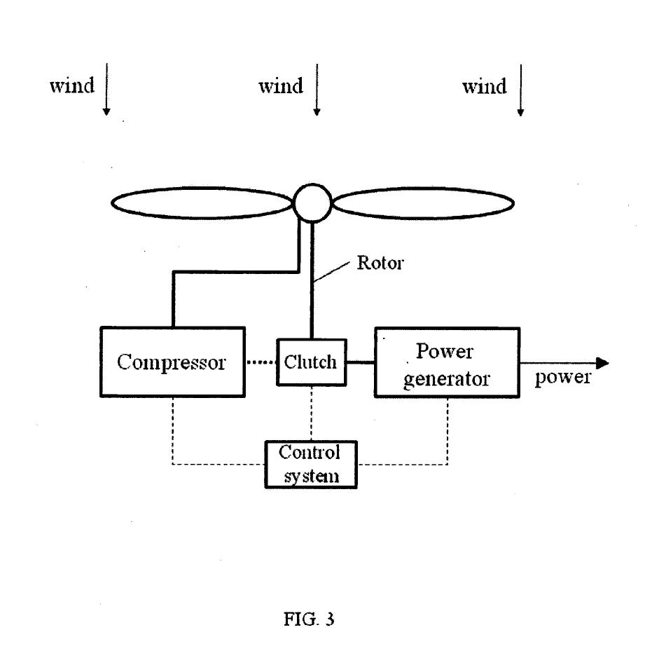

With reference to FIG. 3, the clutch of FIGS. 1 and 2 has coupled the rotor to the power generator, as illustrated by the solid line between the rotor and the power generator. The flow of air (wind) over the blades turns the rotor, which in turn turns the power generator to generate power. In the example of FIG. 3, the compressor is decoupled from the rotor, as illustrated by a broken line between the compressor and the rotor.

Although the compressor, clutch and power generator of FIGS. 1-3 are illustrated as separate units, in some embodiments, the compressor, clutch and power generator are part of an integrated unit. In the illustrated example, the rotor is coupled to an integrated compressor and power generator, as shown by the box around the compressor, clutch and power generator. The control system is part of the integrated compressor and power generator, but in other cases the control system is a separate, standalone unit.

In some embodiments, the turbine systems of FIGS. 1-3 do not include a clutch, and the rotor is coupled to both the power generator and the compressor such that neither the power generator and the compressor is decoupled from the rotor. Such configuration permits the generation of a pressurized fluid and power simultaneously. However, in such cases, the generation of pressurized fluid (e.g., pressurized gas) may be regulated with the aid of, for example, one or more valves that regulate the flow of a gas to the compressor.

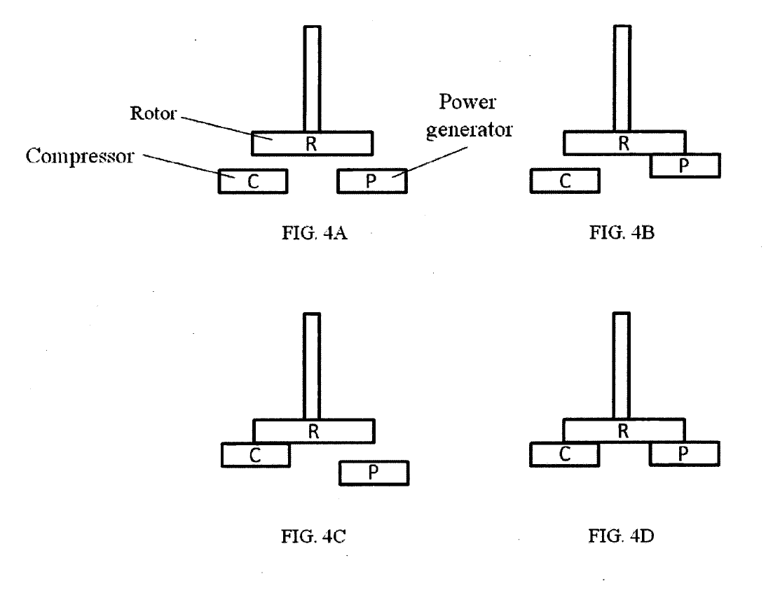

FIGS. 4A-4D schematically illustrate various configurations of an integrated power generator and compressor, in accordance with various embodiments of the invention. FIGS. 4A-4E show cross-sectional side views of a rotor, the power generator and the compressor. The rotor is coupled to a gear (R) that is configured to come in contact with a gear (P) of the power generator and/or a gear of the compressor (C). With reference to FIG. 4A, in an example, both of the compressor (left) and power generator (right) are decoupled from the rotor (middle) with the aid of a clutch (not shown). In FIG. 4B, the power generator is coupled to the rotor and the compressor is decoupled from the rotor. In FIG. 4C, the compressor is coupled to the rotor and the power generator is decoupled from the rotor. In FIG. 4D, both the compressor and the power generator are coupled to the rotor.

In some embodiments, a system including a clutch, rotor, power generator and compressor has the power generator operatively coupled to the rotor without the clutch. Rotation of the rotor drives the power generator, which in turn generates power. The system in such a case is incapable of decoupling the power generator from the rotor. The clutch couples the compressor to (or decouples the compressor from) the rotor, thereby providing energy (e.g., mechanical energy) to the compressor when desired. Thus, the clutch engages a main shaft of the rotor to power the compressor (or blower).

In some embodiments, power to a compressor (or blower) is provided from the power generator, and the compressor is operatively decoupled from the rotor. In such a case, rotation of the rotor drives the power generator, which in turn generates power. At least some of the power is used to power the compressor.

Turbine systems described herein include one or a plurality of blades. At least one blade of the plurality of blades includes one or more blown passages. The blown passages are in fluid communication with the a compressor.

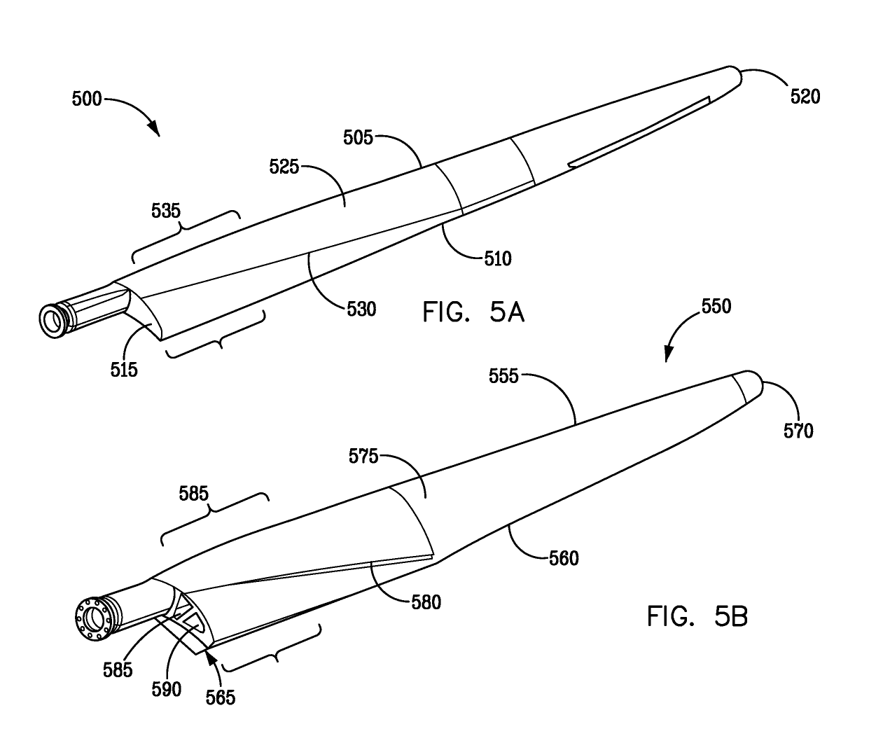

FIG. 5A schematically illustrates a blade 500, as may be used with turbine systems and methods described herein. The blade 500 includes a leading edge 505, trailing edge 510, root portion 515 and tip portion 520. A suction side 525 of the blade 500 opposes a pressure side (not shown) of the blade. The blade 500 includes an opening 530 configured to provide an exit for a fluid, such as air, over a suction side of the blade 500. The opening 530, as illustrated, is a slot extending from about a midpoint of the blade 500 toward the root 515. The leading edge 505 and trailing edge 510 at a span section (or portion) 535 of the blade 500, which is a portion of the blade 500 extending away from the root portion 515, are parallel to one another.

In some cases, the blade 500 includes one or more openings at a pressure side of the blade. In an embodiment, the one or more openings are disposed toward the tip 520 of the blade. In other cases, the opening 530 is disposed at the trailing edge 510 at or near the root 515. In some situations, the blade 500 includes one or more openings at the suction side 525 at or near the tip 520.

FIG. 5B shows a blade 550, in accordance with an embodiment of the invention. The blade 550 includes a leading edge 555, trailing edge 560, root portion 565 and tip portion 570. A suction side 575 of the blade 550 opposes a pressure side (not shown) of the blade. The blade 550 includes an opening 580 extending from about a midpoint of the blade 550 toward the root 565. The leading edge 555 and trailing edge 560 at a span section (or portion) 580 of the blade 550 are parallel to one another. The blade 550 also includes a plurality of openings 585 and 590 for directing air (or other fluid) to one or more openings of the blade 550 in fluid communication with the suction side 575 and/or pressure side of the blade 550, including the opening 580. In some situations, the opening 580 runs the length of one or more of the openings 585 and 590. In some cases, the blade 550 includes one or more openings at a pressure side of the blade. In an embodiment, the one or more openings are disposed toward the tip 520 of the blade. In other cases, the opening 580 is disposed at the trailing edge 560 at or near the root 565. In some situations, the blade 550 includes one or more openings at the suction side 575 at or near the tip 570.

### Methods for Generating a Pressurized Fluid and Power

In another aspect of the invention, methods for generating a pressurized fluid (e.g., air) and power are provided. In some cases, the pressurized fluid and power are alternately and selectively generated. In other cases, the pressurized fluid and power are simultaneously generated.

In some embodiments, methods for producing power comprise providing a turbine system having a rotor selectively coupled to a compressor and a power generator with the aid of a clutch, the rotor operatively coupled to a plurality of blades, at least one blade of the plurality of blades having one or more blown passages for providing a pressurized fluid to a pressure side and/or suction side of the at least one blade.

Next, the rotor is coupled to one of the power generator and the compressor. In an example, the rotor is coupled to the power generator, which generates power upon the rotation of the turbine (and the rotor). In another example, the rotor is coupled to the compressor, which generates a pressurized fluid (for one or more blown passages of the turbine) upon the rotation of the turbine.

Next, the rotor is coupled to the other of the power generator and the compressor. If the rotor was coupled to the power generator, the rotor is coupled to the compressor, and vice versa. Alternatively, the rotor is coupled to both the power generator and the compressor such that a pressurized fluid and power are generated simultaneously upon the rotation of the turbine.

Systems and methods provided herein are combinable with, or modifiable by, other systems and methods, such as, for example, systems and/or methods described in U.S. Pat. No. 6,940,185 to Andersen et al. (“ADVANCED AERODYNAMIC CONTROL SYSTEM FOR A HIGH OUTPUT WIND TURBINE”); U.S. Patent Publication No. 2010/0143122 to Nies et al. (“ACTIVE FLOW CONTROL SYSTEM FOR WIND TURBINE”); U.S. Pat. No. 5,106,265 to A. Holzem (“WIND-TURBINE WING WITH A PNEUMATICALLY ACTIVATED SPOILER”); U.S. Pat. No. 4,197,053 to E. Reinke (“AIR DRIVEN PROPELLER”); U.S. Pat. No. 4,504,192 to Cyrus et al. (“JET SPOILER ARRANGEMENT FOR WIND TURBINE”), U.S. Provisional Patent Application Ser. No. 61/442,761, filed on Feb. 14, 2011; U.S. Provisional Patent Application Ser. No. 61/453,941, filed on Mar. 17, 2011; and U.S. Provisional patent application Ser. No. ______ (Attorney Docket No. 39896-709.101), filed on Jul. 18, 2011 (“TURBINE BLADES AND SYSTEMS WITH FORWARD BLOWN SLOTS”), which are entirely incorporated herein by reference.

Unless the context clearly requires otherwise, throughout the description and the claims, the words ‘comprise,’ ‘comprising,’ and the like are to be construed in an inclusive sense as opposed to an exclusive or exhaustive sense; that is to say, in a sense of ‘including, but not limited to.’ Words using the singular or plural number also include the plural or singular number respectively. Additionally, the words ‘herein,’ ‘hereunder,’ ‘above,’ ‘below,’ and words of similar import refer to this application as a whole and not to any particular portions of this application. When the word ‘or’ is used in reference to a list of two or more items, that word covers all of the following interpretations of the word: any of the items in the list, all of the items in the list and any combination of the items in the list.

It should be understood from the foregoing that, while particular implementations have been illustrated and described, various modifications may be made thereto and are contemplated herein. It is also not intended that the invention be limited by the specific examples provided within the specification. While the invention has been described with reference to the aforementioned specification, the descriptions and illustrations of embodiments of the invention herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A turbine system, comprising:
a rotor coupled to a plurality of blades, at least one blade of the plurality of blades having one or more blown passages for providing a pressurized fluid to a pressure side and/or suction side of the at least one blade, the rotor configured to rotate upon the flow of a fluid over the one or more blades;
a clutch operatively coupled to the rotor;
a power generator operatively coupled to the clutch, the power generator configured to generate power upon the coupling of the rotor to the power generator with the aid of the clutch; and
a compressor operatively coupled to the clutch, the compressor having one or more passages in fluid communication with the one or more blown passages of the at least one blade, the compressor configured to generate the pressurized fluid upon the coupling of the rotor to the compressor with the aid of the clutch.

2. The turbine system of claim 1, wherein the clutch is configured to selectively and alternately couple the rotor to the compressor and the power generator.

3. A turbine system, comprising:
a rotor selectively coupled to a compressor and a power generator with the aid of a clutch, the rotor operatively coupled to a plurality of blades, at least one blade of the plurality of blades having one or more blown passages for providing a pressurized fluid to a pressure side and/or suction side of the at least one blade.

4. The turbine system of claim 3, wherein the clutch is configured to selectively and alternately couple the rotor to the compressor and the power generator.

5. A method for generating power form a turbine system, comprising
providing a turbine system having a rotor selectively coupled to a compressor and a power generator with the aid of a clutch, the rotor operatively coupled to a plurality of blades, at least one blade of the plurality of blades having one or more blown passages for providing a pressurized fluid to a pressure side and/or suction side of the at least one blade;
coupling the rotor to one of the power generator and the compressor; and
coupling the rotor to the other of the power generator and the compressor.
